(19) United States
(12) Patent Application Publication
(10) Pub. No.: US 2024/0386246 A1
(43) Pub. Date: Nov. 21, 2024

(54) COMPUTING SYSTEM, COMPUTER-IMPLEMENTED METHOD, AND COMPUTER PROGRAM PRODUCT FOR INFERRING AN ENTITY AND A RELATIONSHIP RELATED TO A TOPIC FROM UNSTRUCTURED DATA TEXT

(71) Applicant: SR AI Inc, Montreal (CA)

(72) Inventors: Oleksandr SOKOLOV, Toronto (CA); Paul DAIGLE, Montreal (CA); Daniel JACOBS, Toronto (CA)

(73) Assignee: SR AI Inc, Montreal (CA)

(21) Appl. No.: 18/666,875

(22) Filed: May 17, 2024

Related U.S. Application Data
(60) Provisional application No. 63/503,236, filed on May 19, 2023.

(51) Int. Cl. G06N 3/0455; G06F 16/335; G06N 3/096

(52) U.S. Cl. CPC G06N 3/0455; G06F 16/337; G06N 3/096

(57) ABSTRACT

The present computer system and method identify or infer a topic or an entity from unstructured data text, filter passages mentioning the topic and/or entity, and execute a Large Language Model (LLM) with the passages mentioning the topic for inferring at least one entity associated with the topic. The LLM may further infer a relationship between the topic and each of the at least one entity. The computer system and method further distil the topic, the at least one entity and the relationship therebetween into distilled inferred knowledge.

### TECHNICAL FIELD

The present disclosure relates to the field of Large Language Processing (NLP), and more particularly, to the inferring of an entity and a relationship related to a topic from unstructured data text.

### BACKGROUND

Natural Language Processing (NLP) engines are Artificial Intelligence (AI) tools specialized in the processing of text. NLP engines can infer information from huge amounts of text and present the information inferred in a coherent manner.

NLP engines have greatly evolved in the past several years, with advancements driven by large NLP models referred to as Large Language Models (LLMs). ChatGPT™ (part of the GPT family of LLM models, including GPT 3.5, GPT-4, GPT-4 Turbo and 4o, and ongoing releases) followed by other providers of LLMs/Generative AI models (Claude family by Anthropic, and Gemini family by Google) have demonstrated the generative potential of the NLP technology, and its potential application to numerous business and creative environments.

However, LLMs require huge amount of data and extensive processing capabilities to train, improve and maintain, rendering its deployment limited to large scale cloud-based environments. Furthermore, troubleshooting, and biases resolution are complicated by the fact that there is no way to reliably predict how the huge amount of data used for training is interpreted and intercorrelated which results in misinterpretations or inappropriate correlations.

Furthermore, because of their high processing power requirements, LLMs are expensive to run and cannot be used at large scale to infer topic, entity and a relationship between the topic and the entity from unstructured text data.

There is therefore a need for a computer system and a computer-implemented method which better leverages LLM technology to create an end-to-end NLP system for inferring relationship information between entity and topic efficiently and accurately on a large scale.

### SUMMARY

According to a first aspect, the present disclosure relates to a computing system which comprises a processor and memory. The memory stores instructions that, when executed by the processor, cause the processor to perform acts comprising: receiving unstructured data text, the unstructured data text including a mention to a topic; inferring from the unstructured data text the topic; filtering the unstructured data text to identify passages mentioning the topic; instructing execution of a Large Language Model (LLM) for the passages mentioning the topic to infer at least one entity associated with the topic; and distilling the inferred at least one entity and associated topic(s) into distilled inferred knowledge.

According to another aspect, the present disclosure relates to a computing system which comprises a processor and a memory, where the memory stores instructions that, when executed by the processor, cause the processor to perform acts comprising: receiving unstructured data text, the unstructured data text including a mention to a topic; instructing execution of a Large Language Model (LLM) for the unstructured data text to infer the topic and at least one entity associated with the topic; and distilling the inferred at least one entity and associated topic into distilled inferred knowledge.

According to yet another aspect, the present disclosure relates to a computer-implemented method which comprises receiving, by a processor, unstructured data text; analyzing, by the processor, the unstructured data text to identify a topic; filtering the unstructured data text to identify passages mentioning the topic; executing a Large Language Model (LLM) for the passages mentioning the topic to infer at least one entity associated with the topic; and distilling the inferred at least one entity and associated topic into distilled inferred knowledge.

According to another aspect, the present disclosure relates to a computer-implemented method which comprises receiving, by a processor, unstructured data text, the unstructured data text including a mention to a topic; instructing, by the processor, execution of a Large Language Model (LLM) for the unstructured data text to infer the topic and at least one entity associated with the topic; and distilling the inferred topic and associated at least one entity into distilled inferred knowledge.

According to yet another aspect, the present disclosure relates to a computer program product comprising a computer readable storage medium having program instructions embodied therewith. The program instructions is executable by one or more processors to cause the one or more processors to perform operations comprising: receiving unstructured data text, the unstructured data text including a mention to a topic; analyzing the unstructured data text to infer the topic; filtering the unstructured data text to identify passages mentioning the topic; executing Large Language Model (LLM) for the passages mentioning the topic to infer at least one entity associated with the topic; and distilling the inferred at least one entity and associated topic into distilled inferred knowledge.

### BRIEF DESCRIPTION OF THE DRAWINGS

Embodiments of the disclosure will be described by way of example only with reference to the accompanying drawings, in which:

FIG. 1 illustrates examples of unstructured data text;

FIGS. 2A-2C illustrate functional diagrams of various implementations of the present system;

FIGS. 3A-3C are tables of relationships per topics and entities; and

FIGS. 4A-4C are flow charts of the examples of the present method.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address leveraging Large Language Model (LLM) technology in respect of topics and entity, and more particularly with reference to a relationship therebetween into distilled inferred knowledge.

The following terminology is used throughout the present disclosure:
Computing system: an electronic equipment including at least one processor and a computer readable storage medium storing a computer program product comprising program instructions embodied therewith.
Distilled inferred knowledge: capability of inferring an entity associated with a topic (or vice-versa) and/or capability to infer a relationship between an entity and a topic, which is more computationally efficient than the LLM, and which may be used in training smaller models (for example a smaller LLM model or Natural Language Processing (NLP) engines and processors executing such types of engines) to emulate the performance of the LLM on the specific task of inferring or identifying entities, topics and relationships therebetween.
Distilling: Process used in machine learning for transferring knowledge from a larger model into a smaller and more computationally efficient model; the distillation process involves the outputs of a larger model being used as “labelled” training data for the smaller model, to emulate the performance of a larger model on a specific task.
Entity: in the context of the present disclosure, entity is meant to refer to: people, natural or legal bodies, components, structures, organizations, elements, objects, in singular or plural form.
Relationship: refers to any of the following: a role of the entity in the context of the topic, an attribute for the entity in relation to the topic, a sentiment for the entity in reference to the topic, a binary value for the entity in reference to the topic, a relevance value for the entity in relation to the topic, a nominal value for the entity in the context of the topic, and a differential value for the entity in the context of the topic.
Topic: any subject or theme.
Unstructured data text: data provided as text, in an unstructured format.

The present invention relates to the field of Large Language Model (LLM), and more particularly to a computing system, a computer-implemented method, and a computer program product which efficiently leverages LLM for inferring at least one entity related to a topic, and a relationship of each of the at least one entity in the context of the topic, from unstructured data text and distilling the at least one inferred entity related to a topic, and distill a relationship for each of the at least one the entity in the context of the topic into distilled inferred knowledge.

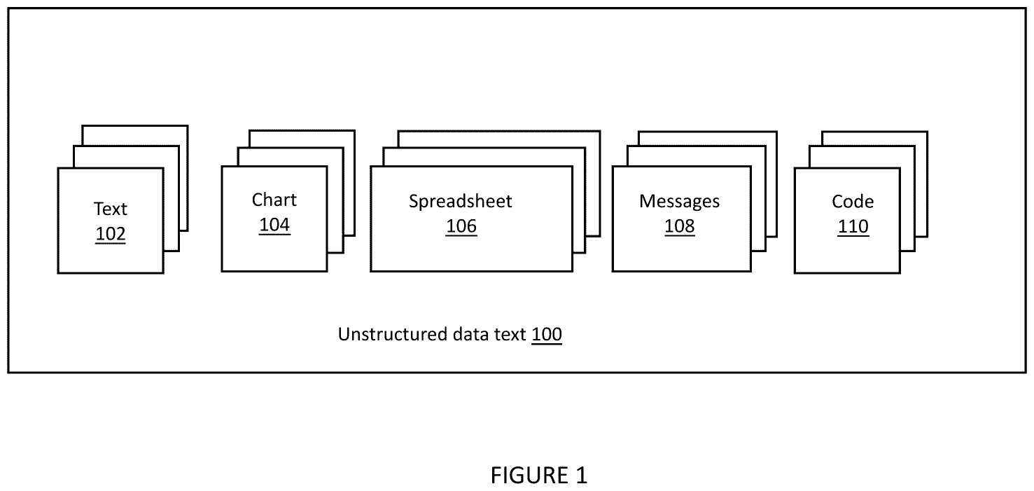

Reference is made to FIG. 1, which illustrates examples of types of unstructured data text 100. Examples of unstructured data text 100 includes text documents 102, charts 104, spreadsheets 106, messages 108 and code files 110. The unstructured data text 100 may further include any other type of data text, which may be received, transferred and/or stored electronically. Although not shown on FIG. 1, the unstructured data text 100 may further include images of unstructured data text which may be processed through Optical Character Recognition (OCR) engine or software or any similar electronic tool or software which is adapted for inferring unstructured data text from images. Furthermore, the unstructured data text 100 may be provided in any electronic format which may be recognizable by a computer. The unstructured data text 100 may be received or collected or a combination thereof from a plurality of electronic sources either connected directly or indirectly. Examples of electronic sources include web pages, websites, blogs, social media posts and messages, Microsoft™ or any other word-processing generated documents, comments on web pages, blogs, vlogs, posts, as well as any other type of electronic document or file containing unstructured data text 100.

The present invention may be implemented on a computing system, on a server, or on a combination of computing system and server. The various implementations will be described hereinafter. Although the present description refers to topic and entity in their singular form, the present computing system, server, and method are not limited to identifying, inferring, and filtering only one topic and or entity at a time but could identify, infer and filter for multiple topics and multiple entities concurrently. However, the choice of the singular form is only to simplify the present description and not to limit the scope of protection.

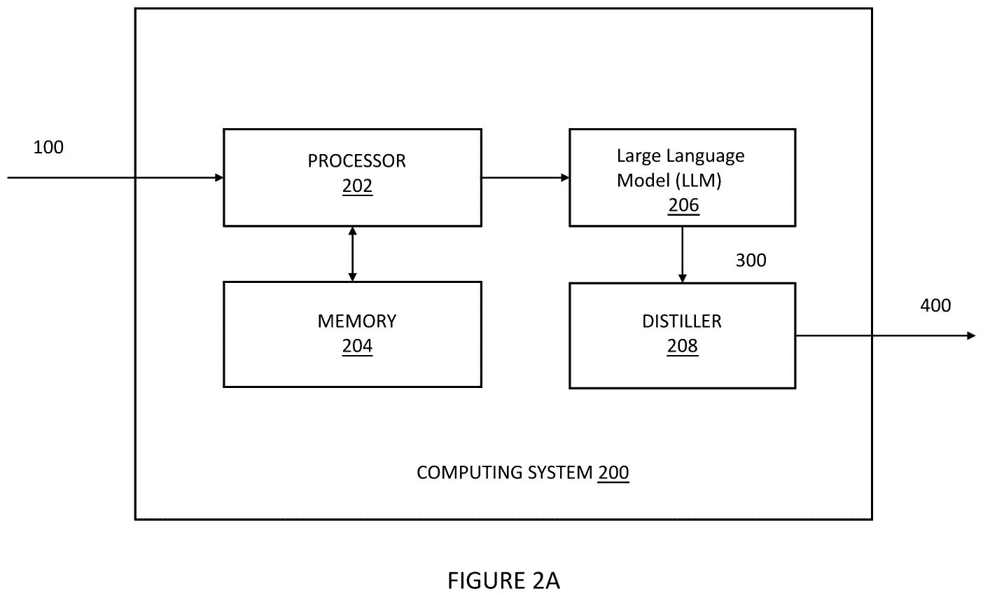

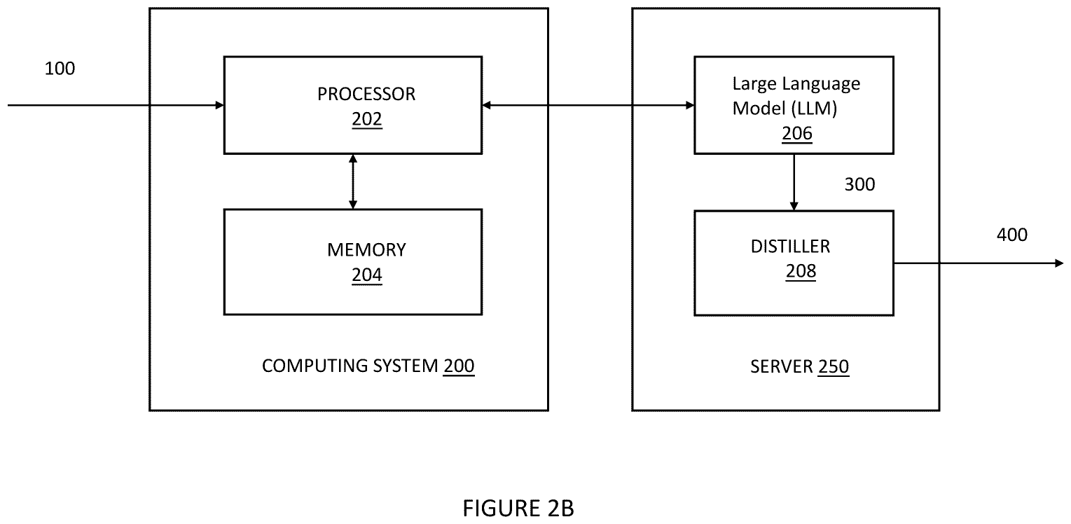

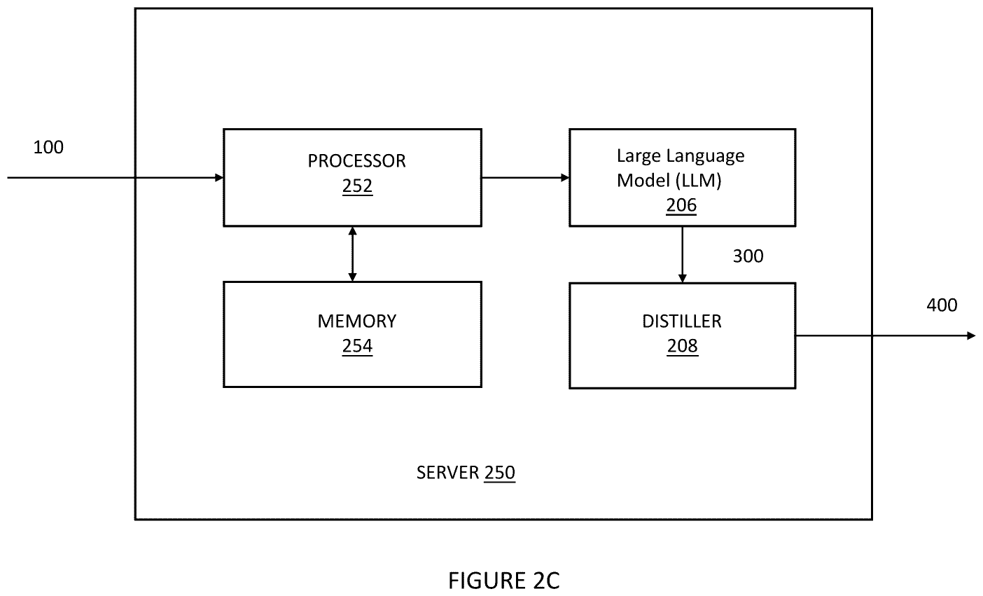

Referring now to FIG. 2A, there is shown a functional diagram of a computing system 200. The computing system 200 receives or collects the unstructured data text 100. The unstructured data text 100 may be received or collected from one or a plurality of computers and/or servers in communication with the computing system 200. The computing system 200 includes a processor 202, a memory 204 and a Lange Language Model (LLM) processor 206. The processor 202 may include one or multiple processors working separately or concurrently. The processor 202 receives or collects the unstructured data text 100. Although not shown, on FIG. 2A, the unstructured data text 100 may be stored in the memory 204 for access by the processor 204. The LLM 206 may be executed by the processor 202 or executed by a separate processor (not shown for simplicity purposes). The memory 204 stores instructions executed by the processor 202.

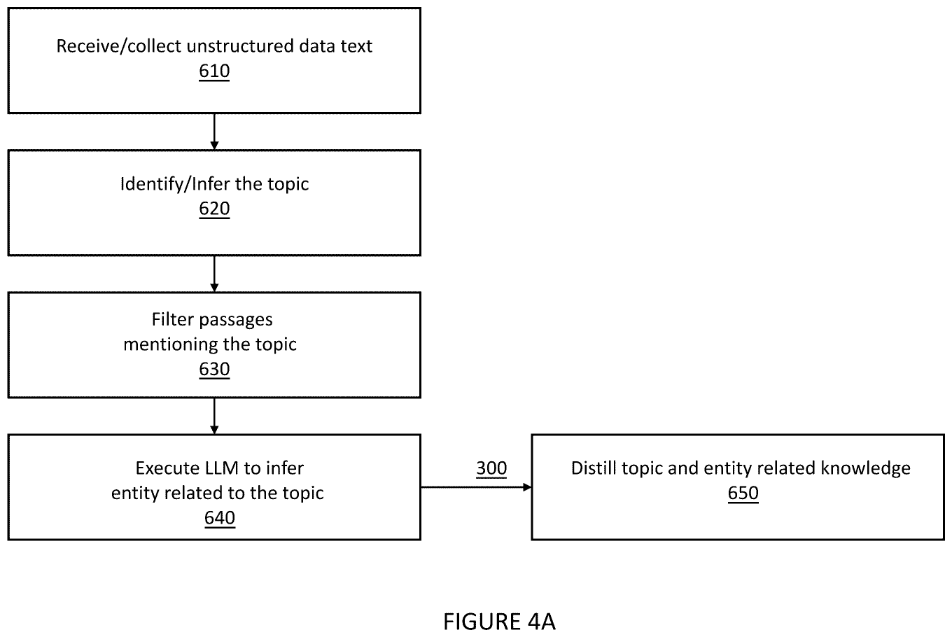

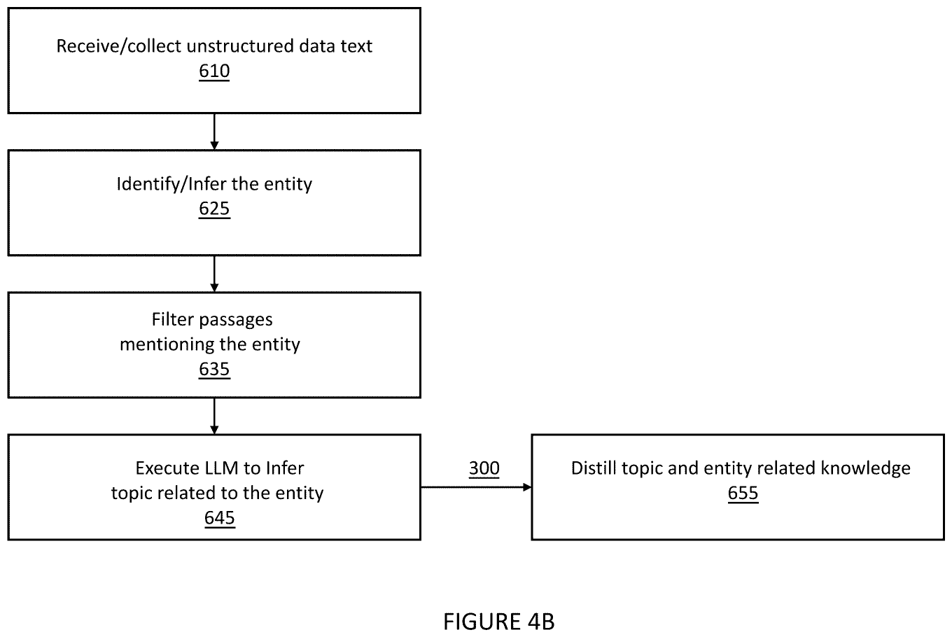

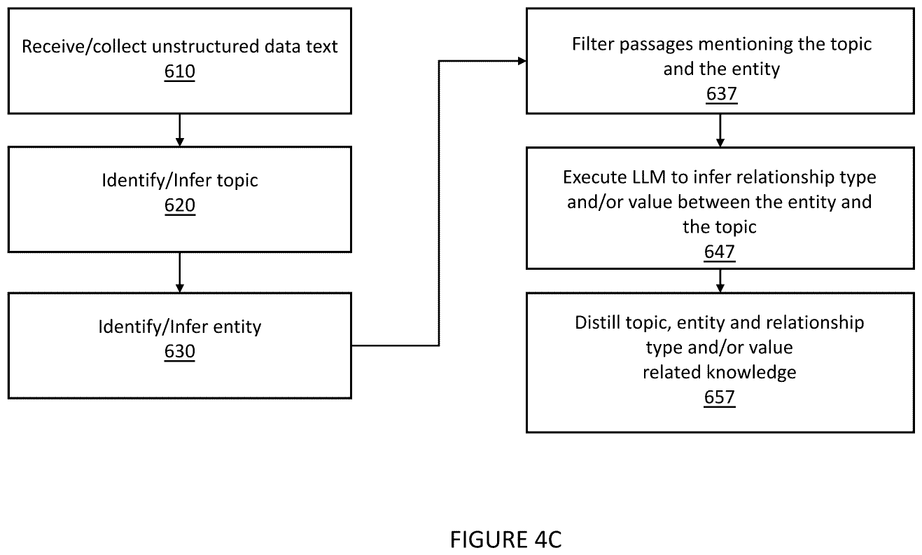

Reference is now concurrently made to FIG. 2A and FIG. 4A, where FIG. 4A is a flow chart of an implementation of the present method. The instructions stored in the memory 204, cause the processor 202 to receive or collect the unstructured data text 100 (step 610). The unstructured data text 100 includes a mention or an inference to at least one topic. A topic may be any subject or theme. The instructions stored in the memory 204 further cause the processor 202 to identify or infer the topic from the unstructured data text 100 (step 620). Any method, software or tool known in the industry may be used to identify or infer the topic, such as for example a Machine Learning (ML) tool, data graphs, Artificial Intelligence, or other from the unstructured data text 100.

Identifying the topic refers to locating in the unstructured data text 100 literal mention of the topic. Inferring the topic refers to deducing from the unstructured data text 100 the topic. Inferring the topic from the unstructured data text 100 may rely on, for example, suggestion(s), mention of a related topic, one or multiple mention of facts related to the topic, or any other written concept used to refer or relate to a topic without literally mentioning the topic in the unstructured data text 100.

When the topic is identified or inferred by the processor 202, the processor 202 then proceeds to filter (step 630) the unstructured data text 100 to identify, in the unstructured data text 100, the passages mentioning or used for inferring the topic. The passages may consist of a number of words before and/or after the mention of the topic, complete sentences where the topic is mentioned, paragraphs where the topic is mentioned, etc. In the case of inferred topic, the passages may consist of a number of words before and/or after the suggestion of or the inference to the topic, complete sentences including the suggestion of the topic or the inference to the topic, paragraphs including the suggestion of the topic or the inference to the topic, etc. Any method known in the industry for filtering unstructured data text 100 may be used to reduce the volume of the unstructured data text 100 to the passages identifying or inferring to the topic, such as for example neural networks.

The processor 202 than instructs execution (step 640) of the LLM 206, also known as prompting the LLM, with the filtered passages of the unstructured data text 100 to infer therefrom an entity associated with the topic. Upon execution, the LLM 206 may infer from the filtered passages of the unstructured data text 100 more than one entity associated with the topic. In such instances, the LLM 206 infers the one or more entity associated with the topic and handles such entities concurrently, sequentially or in parallel. For example, when the LLM 206 infers more than one entity related to the topic, the LLM 206 may create a separate thread of inference for each entity, where the separate threads are associated with the topic. Any other mechanism known in the industry of LLM used to concurrently handle multiple sub-aspect (in the present aspect of the method the entity) may be used. The LLM 206 communicates the inferred entity or inferred entities related to the topic as inferred knowledge 300. The processor 202 further distills (step 650) the inferred knowledge 300, as distilled inferred knowledge 400.

Reference is now made to FIG. 4B, which is a flow chart of another example of the present method performed for example by the system shown on FIG. 2A. The method of FIG. 4B differs from FIG. 4A in that the received or collected (step 610) unstructured data text 100 includes a mention or an inference to at least one entity instead of a topic. An entity may be a person, any natural or legal bodies, components, structures, organizations, in singular or plural form. For example, an entity may refer to a person, a group of persons, a company, a group of companies, an organization, groups of organizations, a living being or groups of living beings, one or multiple things or objects or concepts referred separately or concurrently, etc.

The instructions stored in the memory 204 cause the processor 202 to identify or infer the entity from the unstructured data text 100 (step 625). Any method, software or tool known in the industry may be used to identify or infer the entity, such as for example a Machine Learning (ML) tool, data graphs, Artificial Intelligence, or other from the unstructured data text 100.

Identifying the entity refers to locating in the unstructured data text 100 literal mention of the entity. Inferring the entity refers to deducing from the unstructured data text 100 the entity. Inferring the entity from the unstructured data text 100 may rely on, for example, suggestion(s), mention of a related entity, one or multiple mention of facts related to the entity, or any other written concept used to refer or relate to an entity without literally mentioning the entity in the unstructured data text 100.

When the entity is identified or inferred by the processor 202, the processor 202 then proceeds to filter (step 635) the unstructured data text 100 to identify, in the unstructured data text 100, the passages mentioning or inferring to the entity. The passages may consist of a number of words before and/or after the mention of the entity, complete sentences where the entity is mentioned, paragraphs where the entity is mentioned, etc. In the case of inferred entity, the passages may consist of a number of words before and/or after the suggestion of or the inference to the entity, complete sentences including the suggestion of the entity or the inference to the entity, paragraphs including the suggestion of the entity or the inference to the entity, etc. Any method known in the industry for filtering unstructured data text 100 may be used to reduce the volume of the unstructured data text 100 to the passages identifying or inferring to the entity.

The processor 202 than instructs execution (step 645) of the LLM 206 for the filtered passages of the unstructured data text 100 to infer therefrom a topic associated with the entity. Upon execution, the LLM 206 may infer from the filtered passages of the unstructured data text 100 more than one topic associated with the entity. In such instances, the LLM 206 infers the one or more topics associated with the entity and handles such entities concurrently. For example, when the LLM 206 infers more than one topic related to the entity, the LLM 206 may create a separate thread of inference for each topic, where the separate threads are associated with the entity. Any other mechanism known in the industry of LLM used to concurrently handle multiple sub-aspect (in the present aspect of the method the topic) may be used. The LLM 206 communicates the inferred topic or inferred topics related to the entity as inferred knowledge 300. The processor 202 further distills (step 650) the inferred knowledge 300 as distilled inferred knowledge 400.

Reference is now further made to FIG. 4C which illustrates a flow chart in accordance with another aspect of the present method. In this particular aspect, the instructions stored in the memory 204 cause the processor 202 to identify or infer the topic from the unstructured data text 100 (step 620). As previously discussed, identifying the topic refers to locating in the unstructured data text 100 literal mention of the topic. Inferring the topic refers to deducing from the unstructured data text 100 the topic. Inferring the topic from the unstructured data text 100 may rely on, for example, suggestion(s), mention of a related topic, one or multiple mention of facts related to the topic, or any other written concept used to refer or relate to a topic without literally mentioning the topic in the unstructured data text 100.

When the topic is identified or inferred by the processor 202, the processor 202 continues to identify or infer the entity from the unstructured data text 100 (step 630). As previously discussed, identifying the entity refers to locating in the unstructured data text 100 literal mention of the entity. Inferring the entity refers to deducing from the unstructured data text 100 the entity. Inferring the entity from the unstructured data text 100 may rely on, for example, suggestion(s), mention of a related entity, one or multiple mention of facts or information related to the entity, or any other written concept used to refer or relate to an entity without literally mentioning the entity in the unstructured data text 100.

The processor 202 then proceeds to filter (step 637) the unstructured data text 100 to identify, in the unstructured data text 100, the passages mentioning or inferring to the topic and the entity. The passages may consist of a number of words before and/or after the mention of the topic and the entity, complete sentences where the topic and the entity are mentioned, paragraphs where the topic and the entity are mentioned, etc. In the case of inferred topic and entity, the passages may consist of a number of words before and/or after the suggestion of or the inference to the topic and the entity, complete sentences including the suggestion of the topic and the entity, or the inference to the topic and the entity, paragraphs including the suggestion of the topic and the entity, or the inference to the topic and the entity, etc. Any method known in the industry for filtering unstructured data text 100 may be used to reduce the volume of the unstructured data text 100 to the passages identifying or inferring to the topic and the entity.

The processor 202 than instructs execution (step 647) of the LLM 206 for the filtered passages of the unstructured data text 100 to infer a relationship between the topic and the entity. The relationship between the entity and the topic may be any connection, link or element defining the entity in the context of the topic and may include for example any of the following types of relationships: roles, attributes, sentiments, binary values, relevance values, nominal values, and differential values. The previous list of exemplary types of relationships is not meant to be exhaustive but rather exemplify types of relationships which can be inferred by the present system and method.

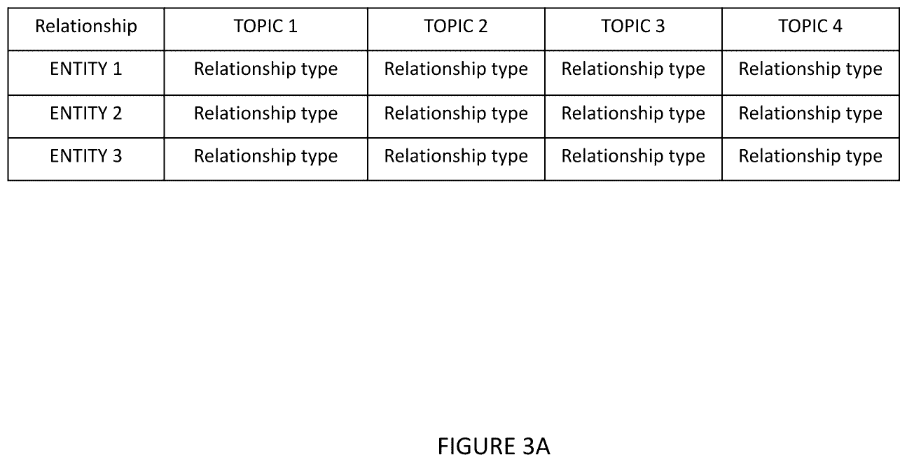

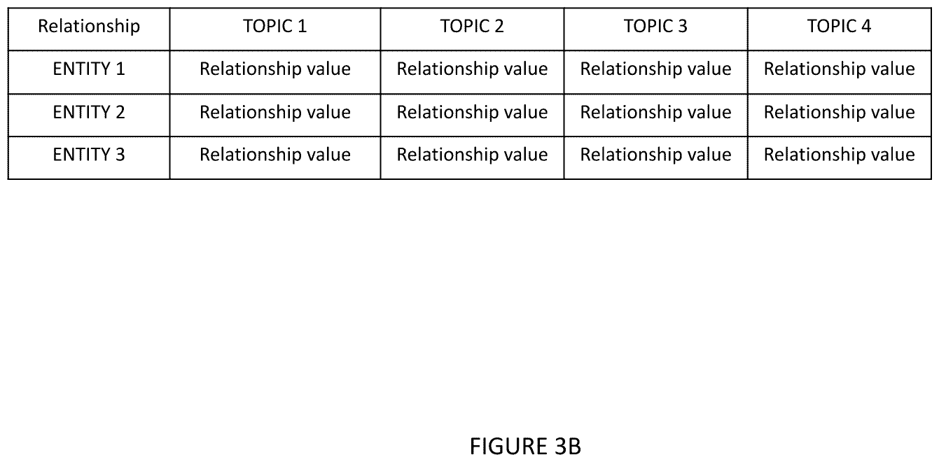

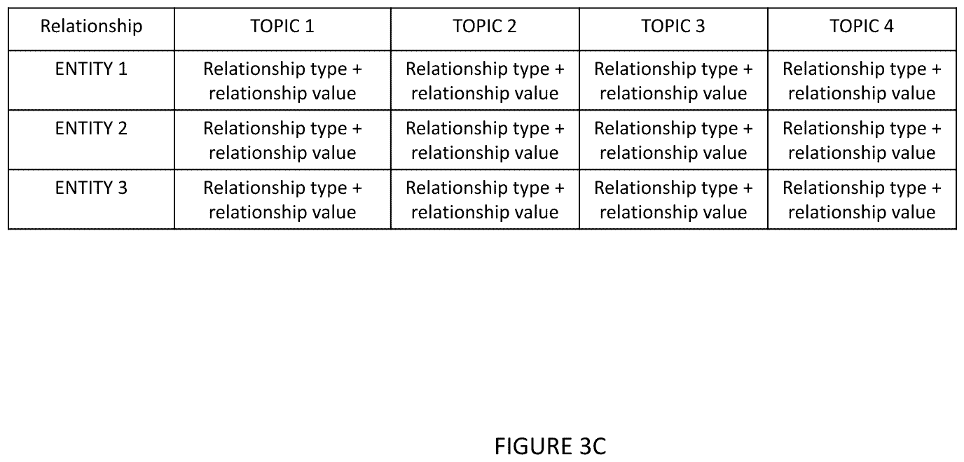

Reference is now further concurrently made to FIGS. 3A-3C which illustrate exemplary tables of types of relationships connecting, defining, or linking the entities in relation to the topics. Those skilled in the art will readily appreciate that the tables shown on FIGS. 3A-3C do not correspond to the inferred knowledge 300 or the distilled relationship, topic, and entity related knowledge 400 but is used only as a visual aid for illustrating types of relationships which may be inferred for multiple entities in relation to multiple topics.

The relationship type may refer to a role. The role may consist of any title, position, responsibility, activity, or any function or part assumed by a person, a group of persons, a thing, or a group of things in relation to the topic.

The relationship type may refer to an attribute. The attribute may consist of any quality, a feature, or a characteristic of the entity in the context of the topic.

The relationship type may refer to a sentiment. The sentiment may consist of an opinion, a view, or an impression towards the entity in relation to the topic.

The relationship value may refer to a binary value. The binary value consists of predefined sets of two elements which can be selected to define the connection or link between the entity and the topic. An example of the relationship type binary value is a yes/no set.

The relationship value may refer to predefined sets of tuple elements which can be selected to define an aspect of the entity in relation to the topic. An example of such a relationship value is a predefined set of tuple elements which may include the following elements: not relevant, interesting, very popular.

The relationship value may refer to a nominal value. The nominal value could for example refer to the financial industry and could correspond to a financial value for the entity in relation to the topic.

The relationship value may refer to a differential value. The differential value may consist of a variance over time in value of the relationship, for the entity, in relation with the topic.

As can be shown on FIG. 3A, the relationship inferred by the LLM 206 may be a relationship type. The relationship type for each entity in relation to each topic may be of different types. Shown on FIG. 3B, the relationship inferred by the LLM 206 may be a relationship value. The relationship value of each entity in relation to each topic may be of different type of values. Shown on FIG. 3C, the relationship inferred by the LLM 206 may be a combination of a relationship type and a relationship value. The relationship type of each entity in relation to each topic may refer to different types, while the relationship value of each entity in relation to each topic may refer to different types of values.

As can be appreciated, it is thus possible to identify or infer first a topic and thereafter infer the entity, or vice-versa. Then, a relationship between the entity and the topic can be inferred by the LLM 206 using the filtered passages. The present approach has several approaches over current solutions. First, by filtering first the unstructured data text to passages including the topic and/or the entity, it limits the volume of data that is being used to prompt the LLM 206. Second, the inferred knowledge 300 is then distilled to generate distilled inferred knowledge 400. The distilled inferred knowledge 400 can then be used to improve filtering and/or inferring operation the processor 202/252 to improve filtering and inferring operations of the processor 202/252. Furthermore, the distilled inferred knowledge 400 can be distributed to other computing systems 200 (not shown) or other servers 250 to also improve filtering and inferring operations. By focusing the processing required by the LLM 206 to specific passages of unstructured data text 100, and more specifically to passages including mentions of entity and/or topic to determine a relationship therebetween, less processing power is required from the LLM 206, and the LLM 206 is used to infer knowledge 300 which can then be distilled into distilled inferred knowledge 400 used for training for example the processor(s) 202/252. The present system, method and computer program product thus use more efficiently the LLM 206, but further use the inferred knowledge 300 generated by the LLM 206 to train the processor(s) 202 and 252 thereby accelerating and improving filtering and/or inferring operation of the processor(s) 202/252. This approach further distributes the improvement of filtering and/or inferring operation of the processor(s) 202/252 over multiple processor(s) 202/252 without requiring any additional resources or interventions.

The method of FIGS. 4A-4C may be executed by the computing systems of FIG. 2A or 2B. Alternatively, the present methods of FIGS. 4A-4C may be executed by a combination of the computing system 200 for the processor and the memory 204, while the LLM 206 and the distiller 208 may be executed by a server 250. The server 250 may be co-located with the computing system 200, or remote from the computing system 200 as for example be cloud-based. In another variant, the processor 252 and the memory 254 may be located at the server 250, with the LLM 206 and the distiller 208. The implementations discussed are for exemplary purposes only, and many other alternatives could be contemplated without departing from the present scope of protection.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A computing system, comprising:
a processor; and
memory storing instructions that, when executed by the processor, cause the processor to perform acts comprising:
receiving unstructured data text, the unstructured data text including a mention to a topic;
inferring from the unstructured data text the topic;
filtering the unstructured data text to identify passages mentioning the topic;
instructing execution of a Large Language Model (LLM) for the passages mentioning the topic to infer knowledge of at least one entity associated with the topic; and
distilling the inferred knowledge of the at least one entity associated with the topic into distilled inferred knowledge.

2. The computing system of claim 1, wherein:
instructing execution of the LLM for the passages mentioning the topic and the entity further infers a relationship between the at least one entity and the topic; and
distilling the inferred knowledge further includes distilling the relationship between the at least one entity and the topic.

3. The computing system of claim 2, wherein the relationship is one of the following: a role, an attribute, a sentiment, a binary value, a relevance value, a nominal value, and a differential value.

4. The computing system of claim 1, wherein the unstructured data text comprises at least one of the following: text, charts, spreadsheets, messages, computer code, and Optical Character Recognized (OCRed) text images.

5. A computing system, comprising:
a processor; and
memory storing instructions that, when executed by the processor, cause the processor to perform acts comprising:
receiving unstructured data text, the unstructured data text including a mention to a topic;
instructing execution of a Large Language Model (LLM) for the unstructured data text to infer the topic and at least one entity associated with the topic; and
distilling the inferred topic and at least one entity associated with the topic into distilled inferred knowledge.

6. The computing system of claim 5, wherein:
instructing execution of the LLM further infers a relationship between each of the at least one entity and the topic; and
distilling the inferred knowledge further includes distilling the relationship between the at least one entity and the topic.

7. The computing system of claim 6, wherein the relationship is one of the following: a role, an attribute, a sentiment, a binary value, a relevance value, a nominal value, and a differential value.

8. The computing system of claim 5, wherein the unstructured data text comprises at least one of the following: text, charts, spreadsheets, messages, computer code, and Optical Character Recognized (OCRed) text images.

9. A computer-implemented method comprising:
receiving, by a processor, unstructured data text;
analyzing, by the processor, the unstructured data text to identify a topic;
filtering the unstructured data text to identify passages mentioning the topic;
executing a Large Language Model (LLM) for the passages mentioning the topic to infer at least one entity associated with the topic; and
distilling the inferred at least one entity associated with the topic into distilled inferred knowledge.

10. The computer-implemented method of claim 9, wherein:
the LLM further infers from the passages of the unstructured data text a relationship between each of the at least one entity and the topic; and
the distilling further distills the inferred relationship between each of the at least one entity and the topic.

11. The computer-implemented method of claim 10, wherein the relationship is one of the following: a role, an attribute, a sentiment, a binary value, a relevance value, a nominal value, and a differential value.

12. The computer-implemented method of claim 10, wherein the unstructured data text comprises at least one of the following: text, charts, spreadsheets, messages, computer code and Optical Character Recognized (OCRed) text images.

13. A computer-implemented method comprising:
receiving, by a processor, unstructured data text, the unstructured data text including a mention to a topic;
instructing, by the processor, execution of a Large Language Model (LLM) for the unstructured data text to infer at least one topic and at least one entity associated with at least one of the topic; and
distilling the inferred at least one topic and at least one entity associated therewith into distilled inferred knowledge.

14. The computer-implemented method of claim 13, wherein:
execution of the LLM further infers a relationship between each of the at least one entity and one of the at least one topic; and
distilling the inferred knowledge further includes distilling the relationship between the at least one entity and the topic.

15. The computer-implemented method of claim 14, wherein the relationship is one of the following: an attribute, a sentiment, a binary value, a relevance value, a nominal value and a differential value.

16. The computer-implemented method of claim 13, wherein the unstructured data text comprises at least one of the following: text, charts, spreadsheets, messages, computer code, Optical Character Recognized (OCRed) text images.

17. A computer program product comprising a computer readable storage medium having program instructions embodied therewith, the program instructions executable by one or more processors to cause the one or more processors to perform operations comprising:
receiving unstructured data text, the unstructured data text including a mention to a topic;
analyzing the unstructured data text to infer the topic;
filtering the unstructured data text to identify passages mentioning the topic;
executing a Large Language Model (LLM) for the passages mentioning the topic to infer at least one entity associated with the topic; and
distilling the inferred at least one entity and associated topic into distilled inferred knowledge.

18. The computer program of claim 17, wherein:
executing the LLM further infers a relationship between the entity and the topic; and
distilling the inferred knowledge further includes distilling the relationship between the at least one entity and the topic.

19. The computer program of claim 18, wherein the relationship is one of the following: a role, an attribute, a sentiment, a binary value, a relevance value, a nominal value, and a differential value.

20. The computer program of claim 17, wherein the unstructured data comprises at least one of the following: text, charts, spreadsheets, messages, computer code, Optical Character Recognized (OCRed) text images.
